(19) United States
(12) Patent Application Publication
(10) Pub. No.: US 2012/0215605 A1
(43) Pub. Date: Aug. 23, 2012

(54) SYSTEM AND METHOD FOR PROVIDING A USER WITH A SINGLE PAYMENT CARD ON WHICH PREPAID AND/OR REWARD BALANCES ARE TRACKED FOR MULTIPLE MERCHANTS

(75) Inventors: Jason M. Gardner, Oakland, CA (US); Clark M. Huang, St. Pete Beach, FL (US); Jason Robert Smith, Crystal Beach, FL (US)

(73) Assignee: MARQETA, INC., Emeryville, CA (US)

(21) Appl. No.: 13/400,888

(22) Filed: Feb. 21, 2012

Related U.S. Application Data
(60) Provisional application No. 61/445,041, filed on Feb. 22, 2011.

(51) Int. Cl. G06Q 20/36; G06Q 30/02

(52) U.S. Cl. 705/14.17; 705/41; 705/14.3

(57) ABSTRACT

The system and method of present invention provides a user with a single account that separately tracks prepaid and/or reward balances from multiple merchants. Multiple merchant purses are associated with the user's account. Each purse corresponds to one merchant, and represents the user's credit balance with the merchant (e.g., prepaid deposits plus reward). The balance associated with each merchant purse is separately tracked. In one embodiment, each merchant purse is associated with its own set of rules for calculating a reward or otherwise managing the purse. When a user deposits prepaid money into a merchant purse, the system that manages the user's account executes any rules associated with the purse related to a deposit. If there is a rule associated with a rewards calculation, a reward amount is calculated in accordance with the rule and, if the reward is greater than zero, the merchant purse is credited with the reward.

### RELATED APPLICATIONS

This application claims the benefit of U.S. Provisional Application No. 61/445,041, filed on Feb. 22, 2011, and titled “System and Method for Enabling a User to Obtain Enhanced Buying Power with Multiple Merchants using a Single Card Associated with Prepaid Dollars,” the contents of which are incorporated by reference herein as if fully disclosed herein.

### BACKGROUND OF THE INVENTION

1. Field of the Invention

This invention relates generally to prepayment and reward card systems and, more particularly, to an account management system that separately tracks prepaid and/or rewards balances for multiple merchants in a single user account.

2. Description of the Background Art

It is desirable for merchants to have users commit prepaid dollars to them. Consequently, many merchants sell gift cards. As incentive to get customers to buy gift cards, some merchants will sell gift card packs in which a user can purchase a set of gift cards for a price that is less than the value of the gift cards. For example, a merchant may offer five $20 gift cards for $80. Thus, for $80 a customer receives $100 in purchasing power at the merchant. This is appealing to customers, but it is not convenient to have purchase a separate gift card from each merchant. Therefore, it is desirable to have a single card on to which a user can load prepaid dollars for multiple merchants in exchange for receiving a reward from the merchants. Also, it is desirable for merchants to have the flexibility to target specific types of deals to specific types of customer (e.g., by geographic area, spending patterns, etc.).

### SUMMARY OF THE INVENTION

The system, computer program, and method of present invention provides a user with a single account that separately tracks prepaid and/or reward balances from multiple merchants. From the user's perspective, the account may be manifested in the form of a physical card (e.g., like a credit card) or in the form of an electronic card. Multiple merchant purses are associated with the user's account. Each purse corresponds to one merchant, and represents the user's credit balance with the merchant (e.g., prepaid deposits plus reward deposits). The balance associated with each merchant purse is separately tracked. The balance within each merchant purse is applicably credited and debited as the user makes deposits and purchases using a card associated with the account. A user may deposit prepaid funds in any of the merchant purses.

In a further embodiment, the user is able to enroll in deals from merchants in which a user receives a reward from a merchant in exchange for depositing a threshold prepaid amount in the purse associated with the merchant. When a user enrolls in a deal, one or more rules are associated with the applicable merchant purse that provide for the calculation of a reward amount in accordance with the deal. Each merchant purse may be associated with its own set of rules for calculating a reward or otherwise managing the purse. When a user deposits prepaid money into a merchant purse, the system that manages the user's account executes any rules associated with the purse related to a deposit. If there is a rule associated with a rewards calculation, a reward amount is calculated in accordance with the rule and, if the reward is greater than zero, the merchant purse is credited with the reward. For merchants with multiple stores or departments, an account management system enables merchants to differentiate between store locations and departments in calculating or using a reward.

In one embodiment, a reward earned by making a deposit or purchase at one merchant may be allocated to a purse associated with another merchant. In this embodiment, the system enables a merchant to offer a deal that provides a reward that is related to another merchant.

In yet a further embodiment of the invention, a user is able to associate an overflow account with one or more merchant purses. In such case, a purchase from a merchant purse that exceeds the balance of the purse will be charged to an overflow account, provided the purse is associated with an overflow account. There may be a default overflow account applicable to all purses, or an overflow account may be specific to a particular merchant purse.

In one embodiment of the invention, rules for calculating rewards may be based on amount spent at a merchant, instead of on prepaid money. In such embodiment, an account management system tracks the amount spent at each applicable merchant, regardless of whether the user uses prepaid dollars or an overflow account.

In a further embodiment of the invention, a master purse is associated with each user account. The account management system enables a user to initially deposit general funds into the master purse and then later transfer funds to specific merchant purses.

In yet another embodiment of the invention, an account management system provides a portal via which a merchant is able to target different deals to different customer.

### BRIEF DESCRIPTION OF THE DRAWINGS

FIG. 1a is a flowchart that illustrates a method according to one embodiment of the present invention.

FIG. 1b is a flowchart that illustrates a method according to a further embodiment of the present invention.

FIG. 2 is a block diagram that illustrates an example of an account management system according to one embodiment of the present invention.

FIGS. 3-4, 6-8, and 10 are flowcharts that illustrate example operations of an account management system according to one embodiment of the present invention.

FIG. 5 is a block diagram that illustrates an example of the structure of a user account in a database.

FIGS. 9a-9d are pictorial representations of a user's account according to multiple embodiments of the present invention.

### DETAILED DESCRIPTION OF THE PREFERRED EMBODIMENTS

The system and method of present invention provides users each with a single account that separately tracks prepaid and/or reward balances from multiple merchants. The account may be associated with one or more “payment cards” that a user can use to purchase goods and services the same way a credit or debit card is used. Although an account may be associated with multiple cards (at the user's option), the system enables the user to have just one card that can be used for multiple merchants. The payment card may in physical form (like a plastic credit or debit card) or in electronic form.

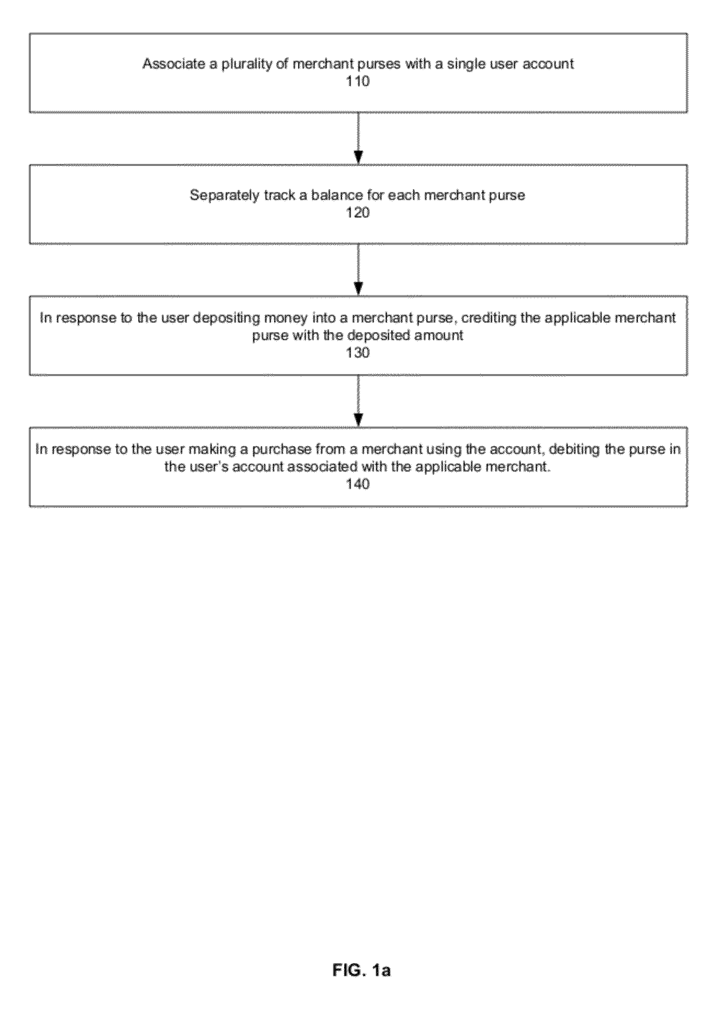

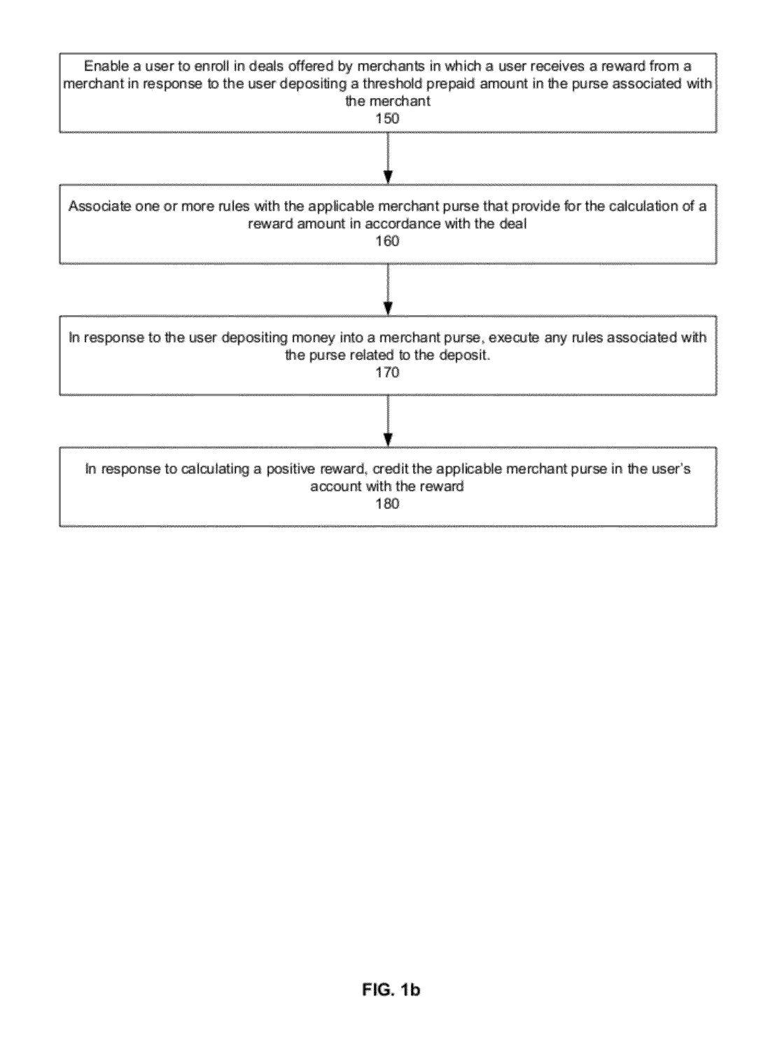

As illustrated in FIG. 1a, multiple merchant purses are associated with the user's account (step 110). Each purse corresponds to one merchant, and represents the user's credit balance with the merchant (e.g., prepaid deposits plus reward deposits). The balance associated with each merchant purse is separately tracked (step 120). The balance within each merchant purse is applicably credited and debited as the user makes deposits and purchases (steps 130, 140) using a payment card associated with the account. A user may deposit prepaid funds in any of the merchant purses. As will be described in more detail below, a user's incentive for depositing prepaid dollars may be to receive a reward that provides the user with additional purchasing power with the merchant. In the preferred embodiment, a user's prepaid balance is maintained within a subaccount in the purse.

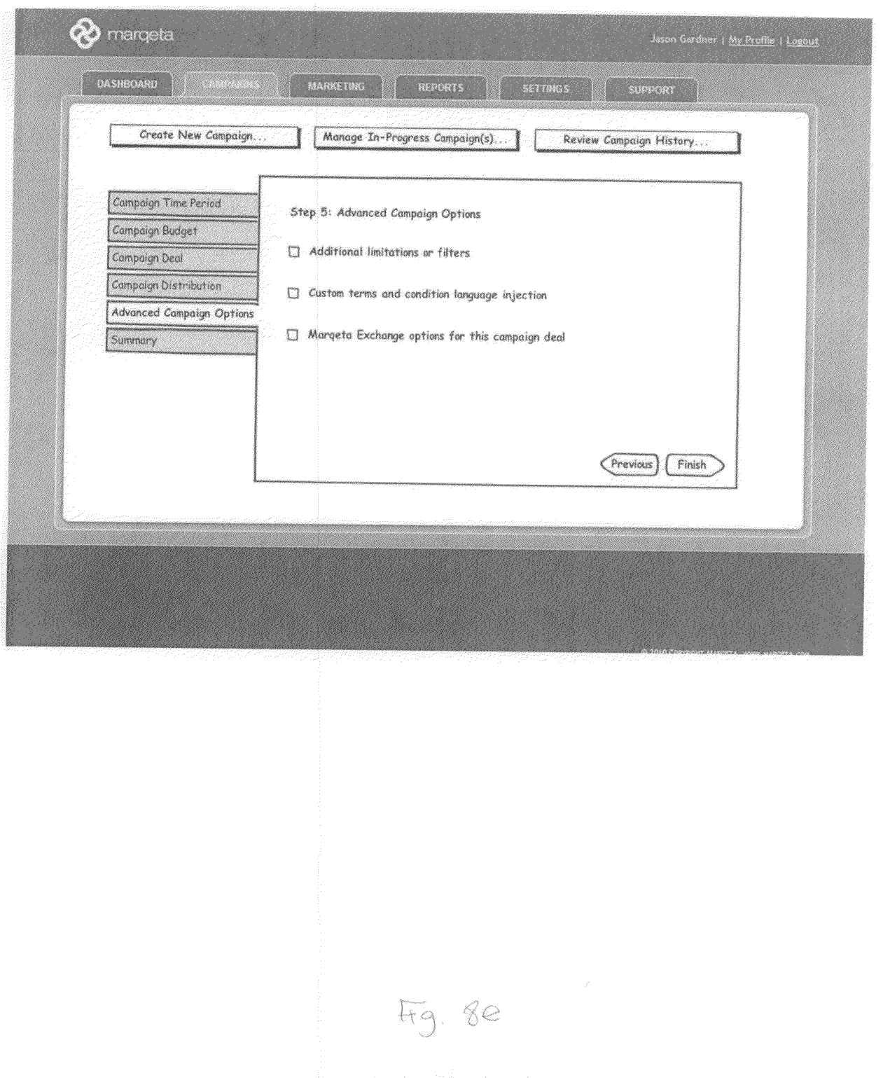

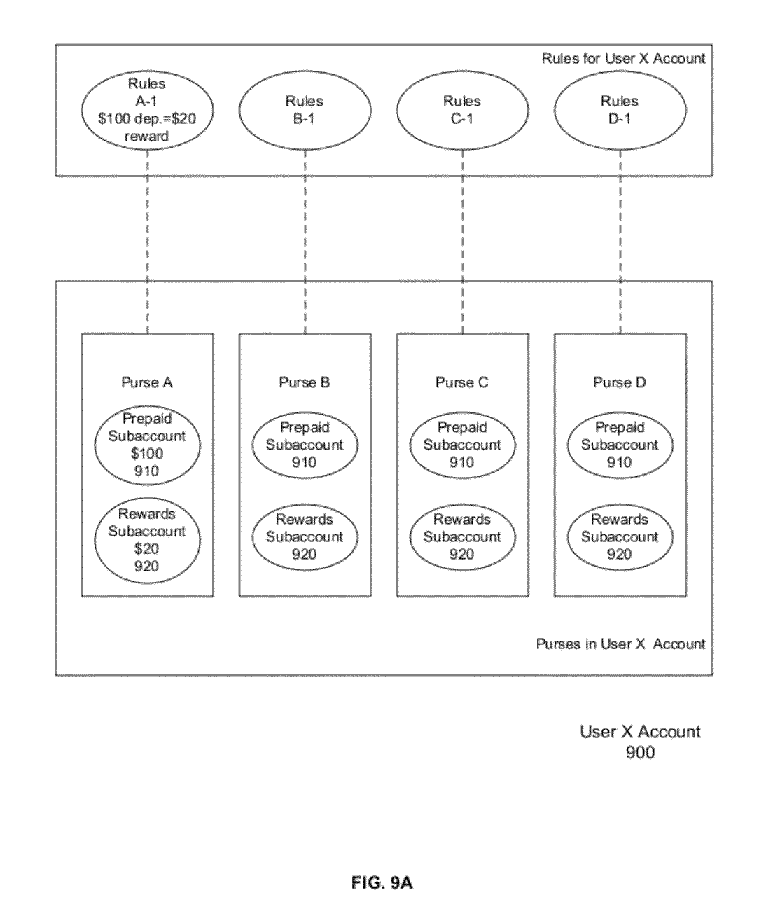

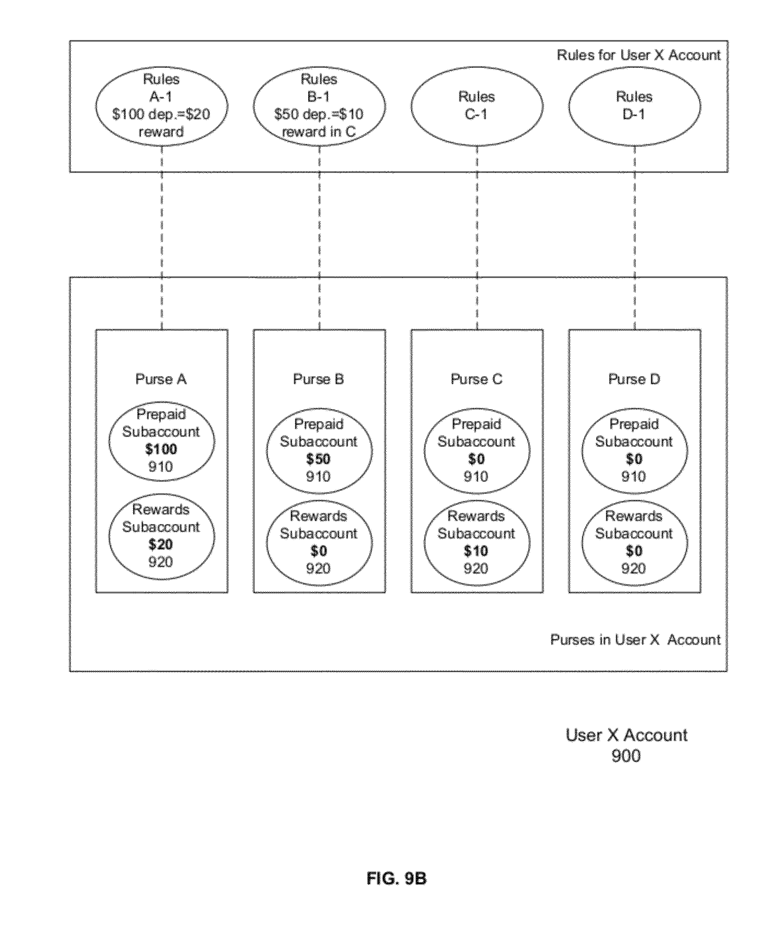

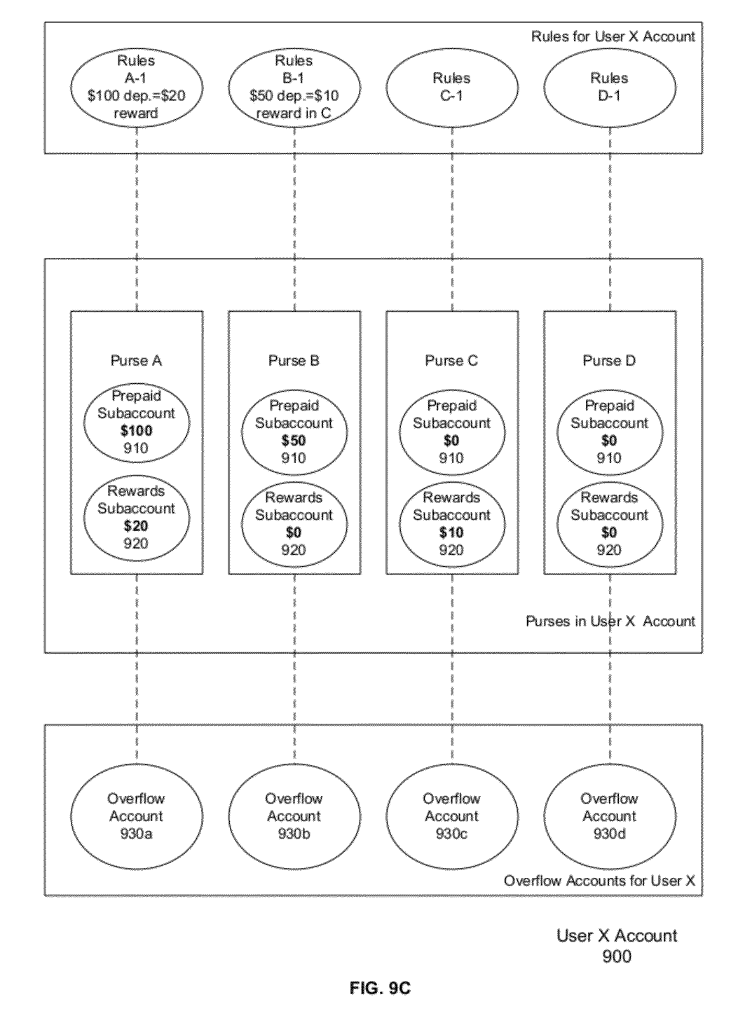

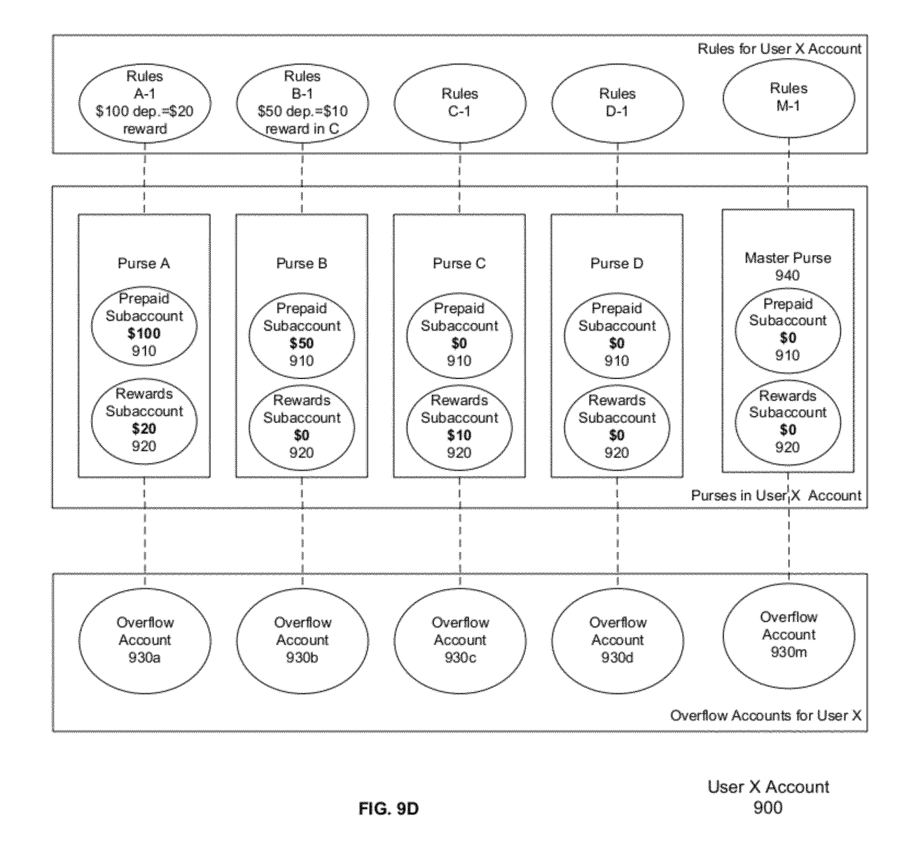

A prepaid deposit into a merchant purse is a commitment of money by the user to that merchant. In most cases, once a user makes a prepaid deposit into a merchant purse, the user can spend the money on only purchases from the merchant. In one embodiment, illustrated in FIG. 1b, the user is able to enroll in deals from merchants in which a user receives a reward from a merchant in exchange for depositing a threshold prepaid amount in the purse associated with the merchant (step 150). For example, a user may sign up for a deal in which the user receives a $20 reward from a merchant in exchange for a prepaid deposit of $100 in the merchant's purse in the user's account. When a user enrolls in a deal, one or more rules are associated with the applicable merchant purse that provide for the calculation of a reward amount in accordance with the deal (step 160). Each merchant purse may be associated with its own set of rules for calculating a reward or otherwise managing the purse. FIG. 9a illustrates a pictorial representation of an example user's account 900 according to this embodiment of the present invention. In this example, the user's account is associated with merchant purses A, B, C, and D. Each purse has a subaccount 910 for tracking prepaid balances and a subaccount 920 for tracking reward balances. Each purse may be associated with its own set of rules (A-1, B-1, C-1, D-1) for calculating a reward.

When a user deposits prepaid money into a merchant purse, the system that manages the user's account executes any rules associated with the purse related to a deposit (step 170). If there is a rule associated with a rewards calculation, a reward amount is calculated in accordance with the rule and, if the reward is greater than zero, the merchant purse is credited with the reward (step 180). For example in FIG. 9a, the user has deposited $100 in purse A. The deposit is tracked in subaccount 910 in purse A. There is a rule A-1 associated with purse A that states the user receives a $20 reward in exchange for every $100 of prepaid money deposited into the purse. Consequently, purse A is credited with $20 reward in rewards subaccount 920. The user's total credit with the merchant is $120.

Because each merchant purse may be associated with its own set of rules, there are any number of options for the rules. For instance, a rule can specify whether a reward is calculated based on (i) a one-time prepaid deposit or (ii) any number of deposits over a certain time period. In addition to having rules for how a reward is calculated, there may also be rules for how a reward may be used. For example, a merchant may specify that a reward may be used only at a particular store or a particular department, or the merchant may have restrictions on the types of goods and services for which a reward may be used.

In one embodiment, a reward earned by making a deposit or purchase at one merchant may be allocated to a purse associated with another merchant. In this embodiment, the system enables a merchant to offer a deal that provides a reward that is related to another merchant. For example, a department store may offer a deal that grants a user a $10 grocery store credit in exchange for a prepaid deposit of at least $50 in the department store purse. The rules associated with the department store purse would reflect this deal. When a user deposits $50 in the department store purse, a $10 credit would be added to the purse for the grocery store. This is depicted in FIG. 9b. In this case, User X has deposited $50 in purse B. A rule B-1 associated with purse B specifies that, because of User X's $50 deposit, User X has earned a $10 reward for purse C. Consequently, $10 is deposited in the rewards subaccount 920 for purse C.

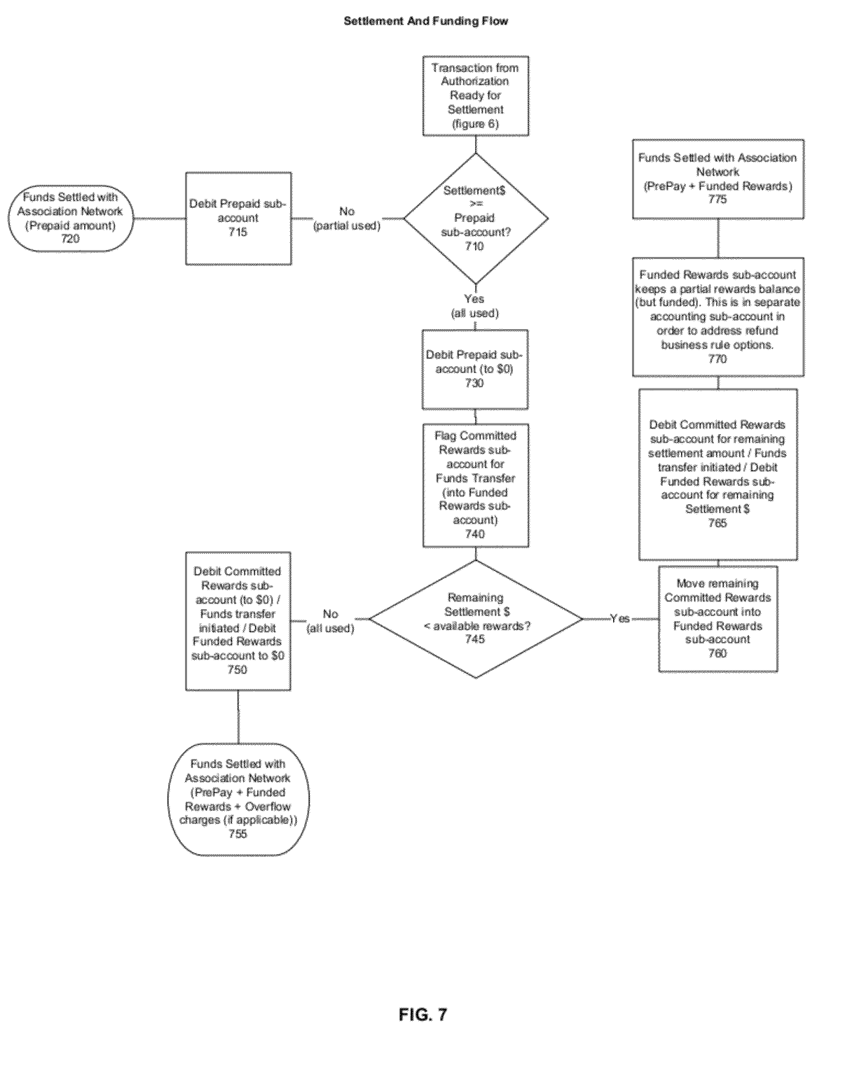

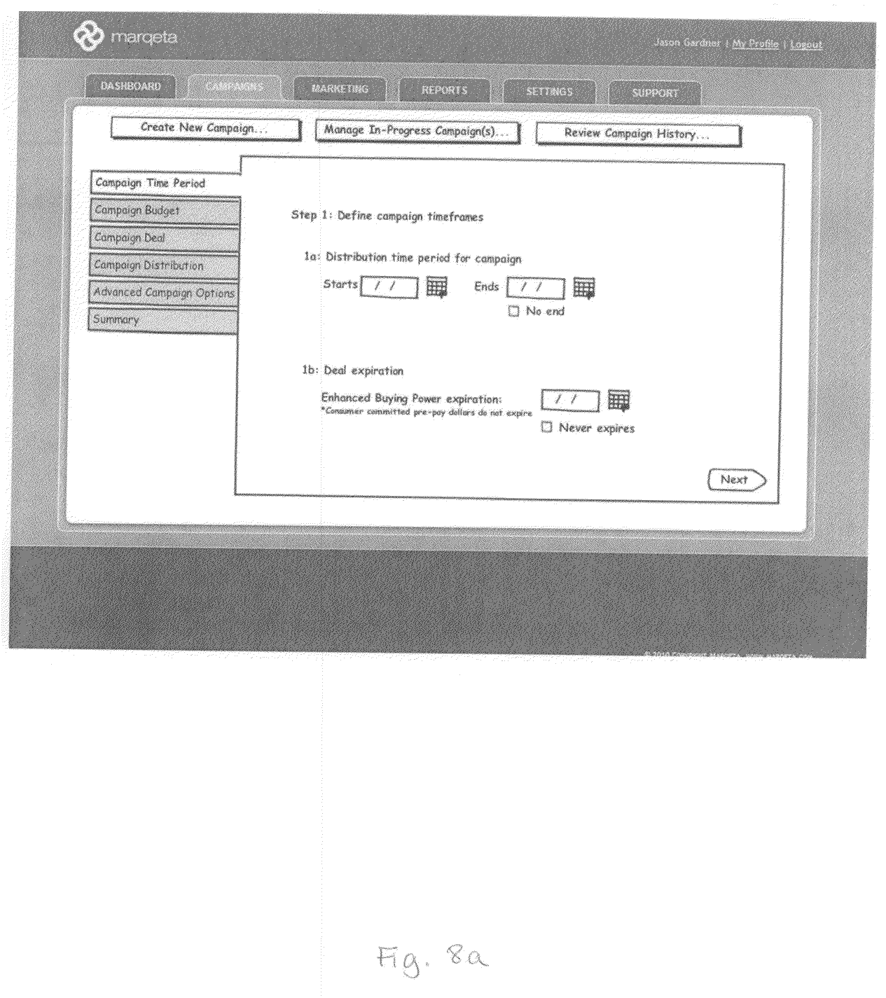

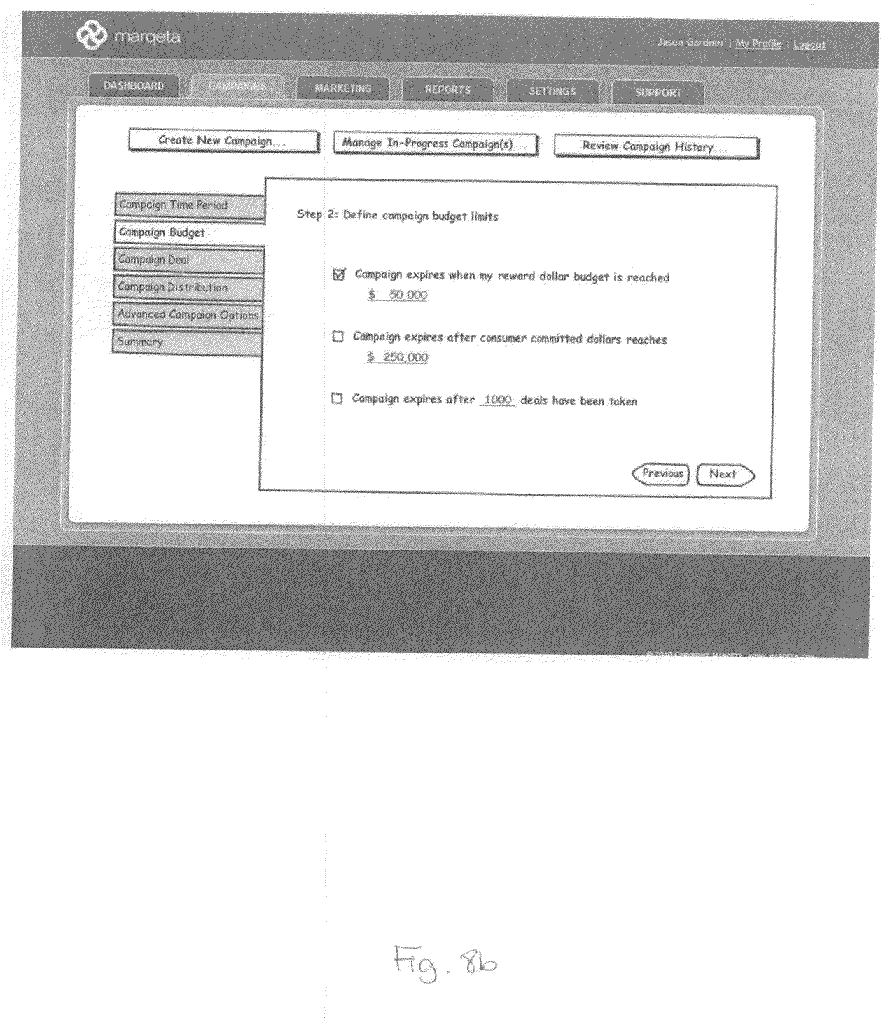

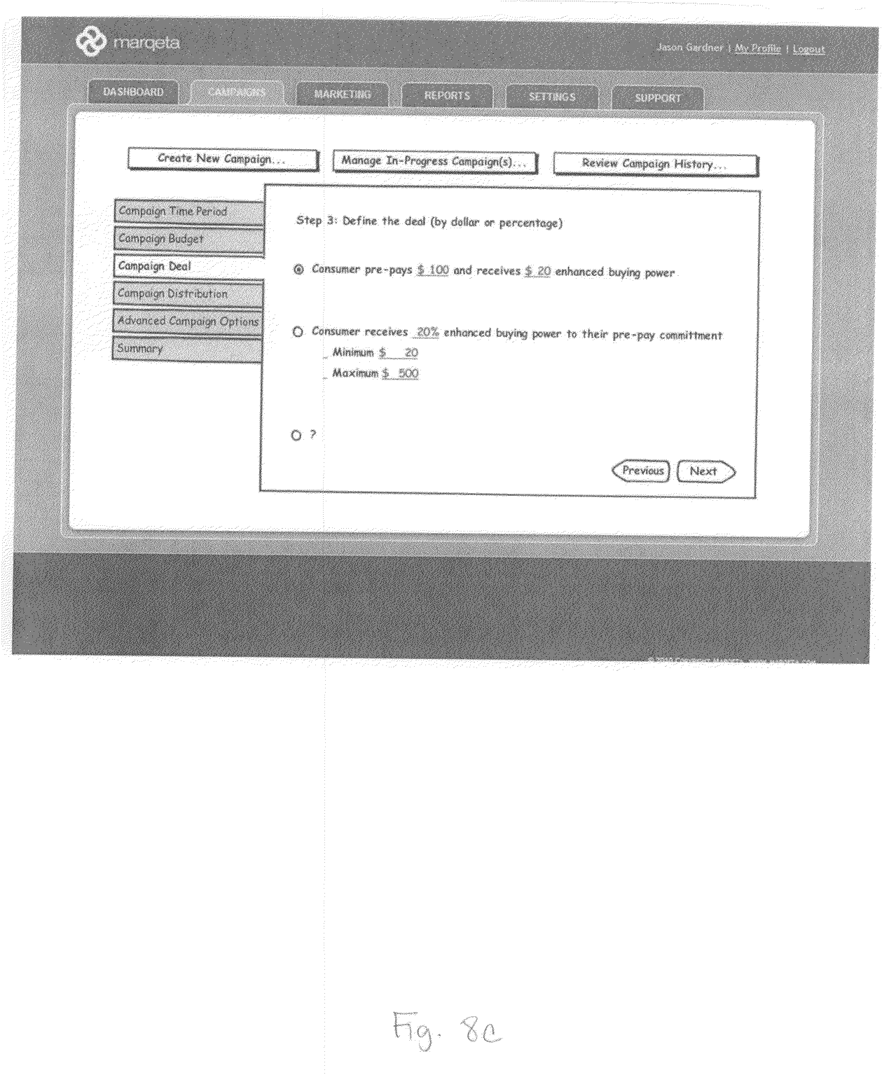

In a further embodiment, the account management system enables merchants to offer deals with rewards without having to fund the reward upfront. For example, if the merchant offers a user a deal in which a user prepays $100 in exchange for $120 in buying credit and the user accepts, the merchant does not have to fund the $20 rewards payment upfront. Instead, the merchant only need fund the $20 reward payment once a consumer-spending threshold has passed. This is described in more detail with respect to FIG. 7.

In yet a further embodiment of the invention, a user is able to associate an overflow account with one or more merchant purses. In such case, a purchase from a merchant purse that exceeds the balance of the purse will be charged to an overflow account, provided the purse is associated with an overflow account. For instance, if the credit balance in a particular purse is $50, and the user makes a purchase of $70 using the purse, $50 will be debited from the purse and $20 will be charged to the overflow account associated with the purse. An example, of an overflow account is a credit card to which overflow balances may be charged. As shown in FIG. 9c, each purse may be associated with its own overflow account 930. In one embodiment, a user is able to specify a default overflow account that will apply to all merchant purses, unless the user otherwise specifies a specific overflow account to a particular merchant purse. For example, assume a user has a NORDSTROM's purse in her account. She may decide to designate her NORDSTROM's charge card as the overflow account for her NORDSTROM's purse, and designate another credit card as the default overflow account that will be used for all other purses.

For purses associated with overflow accounts, rules for calculating rewards need not be based on prepaid dollars. Instead, they may be based on the amount spent by the user on goods or services. For example, a sandwich store may offer a deal that if a user spends $30 at the sandwich store within a specified period of time, the user receives $5 credit towards future sandwich purchases. In such case, it does not matter whether or not the user's purchase are with prepaid dollars or with charges to an overflow account. In one embodiment, the user account does not include any merchant purses for prepaid dollars and only separately tracks merchant spending for a number of merchants.

In one embodiment, for merchants with multiple stores or departments, the system enables merchants to differentiate between store locations and departments in calculating or using a reward. For example, a department store may calculate a reward at rate A for cosmetic purchases and a reward at rate B for clothing purchases. In one embodiment, each of a merchant's stores is assigned a merchant ID, and each register may be assigned a separate terminal IDs. The present invention enables rules for calculating and using rewards to be written at the merchant level, merchant ID level, and/or the terminal ID level.

In one embodiment of the invention, a master purse is associated with each user account, as illustrated in FIG. 9d with master purse 940. The account management system enables a user to initially deposit general funds into the master purse and then later transfer funds to specific merchant purses. For example, a user may direct deposit paychecks into a master purse and then later allocate these funds to various merchants as needed by the user. The master purse may be used as a depository account for payroll, cash load, and person-to-person money transfers. The master purse allows the account to be used as a standard prepaid card at non-boarded merchant (i.e., merchants who are not enrolled with the account management system to provide deals to users). A master purse may be designated as an overflow account. For instance, a user may designate a master purse as a first overflow account and a credit/debit card as a second overflow account. A master purse may also have a rewards subaccount, as the operator of the account management system may offer the user rewards in exchange for direct depositing paychecks in the master purse or making other deposits.

As indicated above, information related to the user's account may be loaded onto a physical “payment card” that is provided to the user. In this embodiment, the card may be used and swiped at a merchant location like credit or debit card. In an alternate embodiment, the card is in electronic form (e.g., on a user's mobile computing device). In this embodiment, there may be an application on a user's portal computing device (i.e., mobile phone, mobile tablet, etc.) that can be scanned by a merchant to obtain identifying information about the user's account.

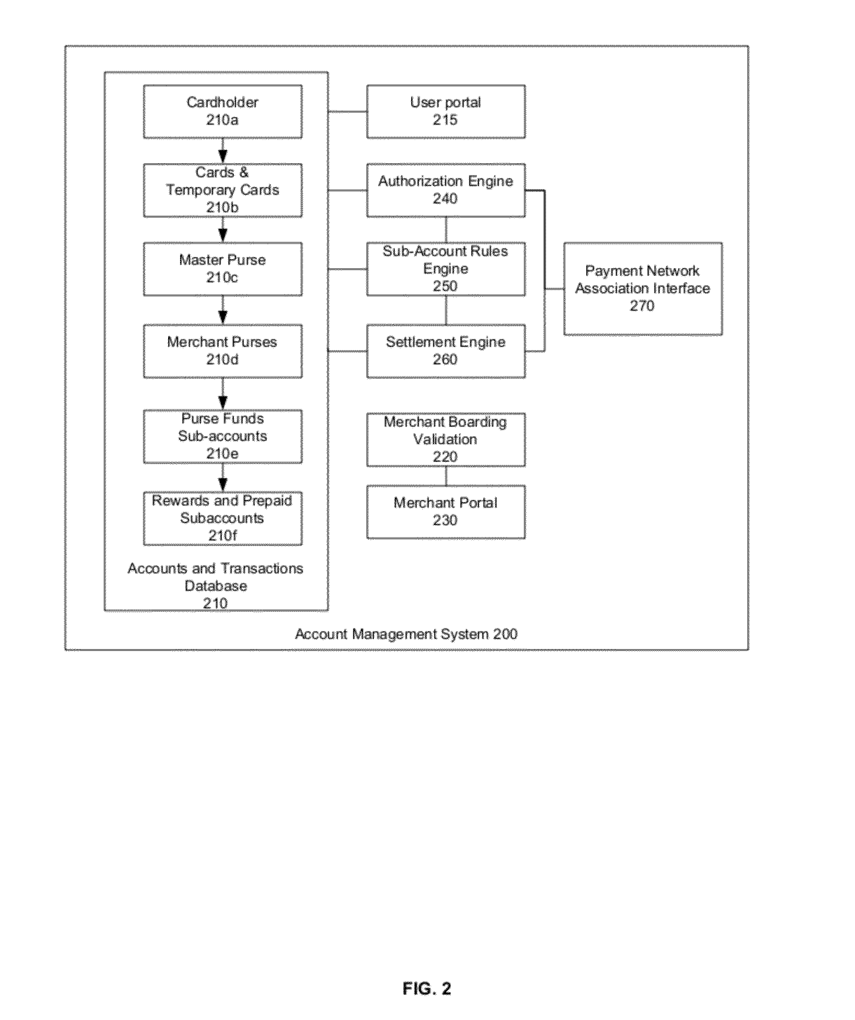

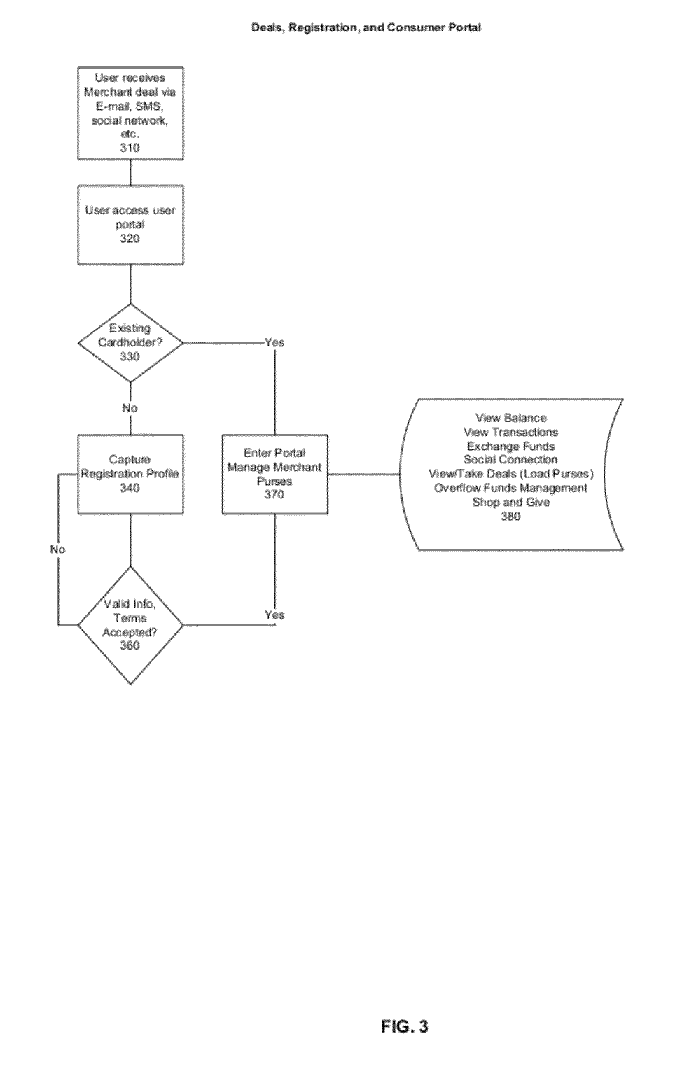

FIG. 2 illustrates an example of account management system for managing the above-described user accounts. System 200 and the corresponding discussion in FIGS. 3-8 and 10 is only an example, and the method of the present invention may be implemented in other ways.

System 200 includes a user portal 215 that allows basic payment card functionality and management of merchant relationships. Via the user portal 215, a user can check balances of each individual merchant purse on a payment card associated with the user's account, view recent transactions, exchange prepayment credits with other users, view and accept new deal offers, and/or share information via social networks. The user portal 215 is also the avenue for a user to activate a card before initial use at a brick and mortar merchant or an online merchant.

System 200 includes a Merchant Boarding Validation Module 220. Each merchant register at which payment can be accepted is associated with a terminal ID, and the Merchant Boarding Validation Modules 220 validates merchant's terminal IDs to ensure that the merchant has provided the correct terminal ID for each of its register locations.

System 200 includes a Merchant Portal 230 via which a merchant can manage deals and campaigns. In one embodiment, the Merchant Portal 230 also includes various reporting tools to enable a merchant to see information related to various campaigns and deals.

System 200 includes an Accounts and Transactions Database 210. The database stores information on each account holder (sub-account layer 210a). In one embodiment, each user account in the database points to each of the user's cards for the account (whether physical cards or electronic cards) (subaccounts 210b), including any temporary cards. Each card points to the master purse (if applicable) and the merchant purse(s) associated with such card (subaccounts 210c and 210d). Each merchant purse points to purse funds sub-accounts 210e that are used to manage the accounting when a user attempts to purchase a product/service using the user account. The purse funds sub-accounts 210e specify available purse funds, as well as the various bank/institution transaction fees that accrue when the prepayment card is used to make a purchase. The purse funds available sub-account points to further sub-accounts 210f that track prepaid and rewards dollars. Subaccounts 210f specify the prepaid dollar amounts, committed (but unfunded) merchant reward dollar amounts, and funded merchant reward dollar amounts.

System 200 includes an Authorization Engine 240 that processes account purchases. The Authorization Engine 240 traverses Database 210 to determine whether or not a user has sufficient funds, or an overflow account, in an applicable merchant purse to complete a purchase from the merchant using the account. System 200 also includes a Sub-Accounting Rules Engine 250 that applies sub-accounting rules to the sub-account layers 210e and 210f within Database 210. The sub-accounting rules define which funds in the subaccounts layer 210f (e.g., prepaid funds vs. reward funds) are used to settle a transaction. System 200 also includes a Settlement Engine 260 that manages the settlement and funding of transactions. System 200 includes a Payment Network Association Interface 270.

FIG. 3 illustrates the interaction with the user and the user portal 215 in one embodiment of the present invention. The user portal registers users for new cards for an account, and it is enables users to activate physical cards before initial user at merchants. When the user receives notice of a prepayment merchant deal vie email, text, a social network, or other means (step 310), the user accesses the user portal 215 via the web to commence the registration process or login to his account in order to sign up for the deal (step 320). The user portal 215 determines whether or not the user is an existing accountholder. If the user is not registered, the user portal 215 commences the registration processes and prompts the user for information needed to register the user. The user portal 215 then attempts to validate the information received from the user. If the information is not complete and valid, the user portal 215 returns to step 340. Otherwise, the system proceeds to step 370.

Once the user is registered, or if the user is already registered, the user proceeds to a portal that enables a user to manage purses in the account (step 370). From there, the user can check balances, view recent transactions, accept new deals, and designate overflow accounts (step 380). In some embodiments, the user may also exchange prepayment credits with other users, share information via social networks, and register for “shop and give” programs that enable a user to donate a certain percentage of his spending or his reward to charity.

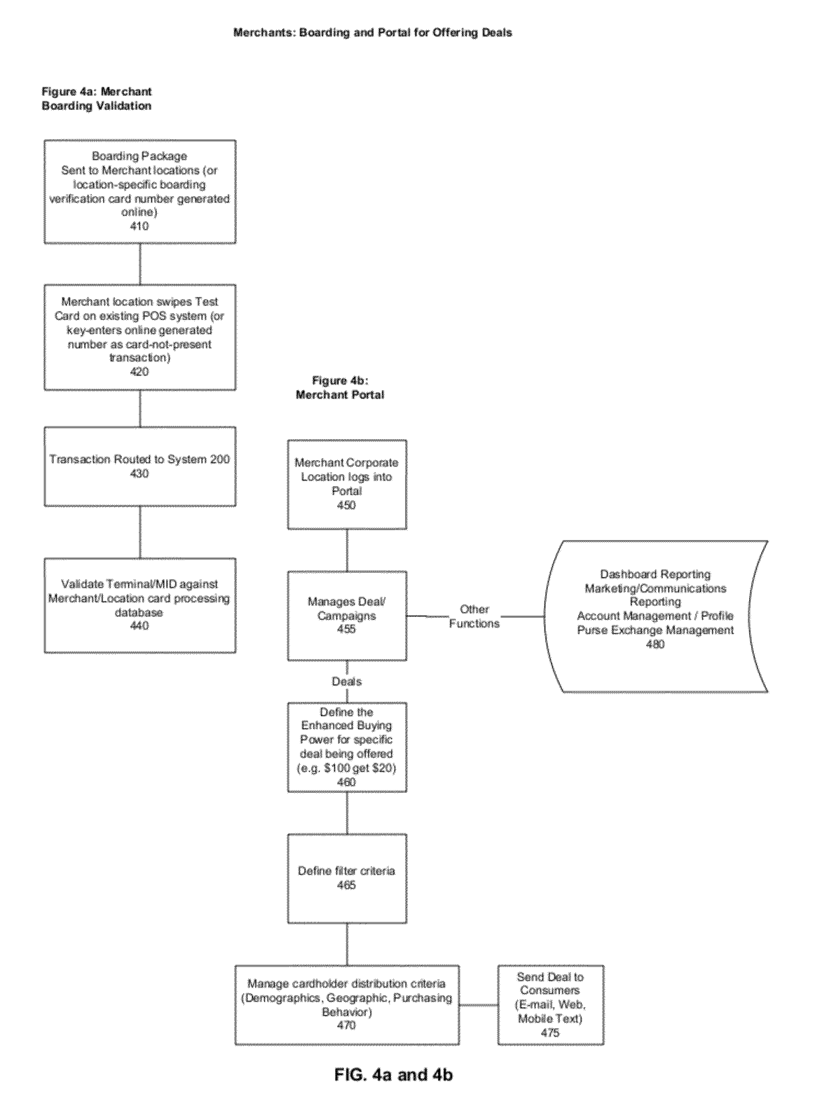

FIG. 4a illustrates the account management system validates terminal IDs at merchant locations in one embodiment of the present invention. In response to a merchant registering with System 200, a merchant “boarding package” is sent to each of the participating merchant locations, or a location-specific boarding verification card number is generated online (step 410). The boarding package includes a test card that is designed to transmit merchant ID and terminal ID data back to System 200. An employee at the merchant location swipes the test card on an existing point of sale (POS) system (i.e., the same system a merchant uses to swipe a credit card) (step 420). Alternatively, if the merchant has an electronic boarding verification card number, then the merchant punches the number into their point-of-sale (POS) system as a card-not-present transaction. Either way, the transaction, which includes the terminal ID and merchant ID, is routed back to the Merchant Board Validation Module 220 (step 430). The Merchant Board Validation Module 220 then validates the received terminal ID for the location against the terminal ID previously provided by that merchant (and stored in a database) for the location (step 440).

FIG. 4b illustrates the merchant interaction with the Merchant Portal 230 according to one embodiment of the present invention. A merchant logs into the Merchant Portal 230 (step 450). Via the merchant portal 230, a merchant can manage deals/campaigns (step 455). Steps 460-470 illustrate an example of the process for defining a deal. The merchant defines the enhanced buying power for the specific deal being offered (e.g., prepay $100 and get $120 in buying power) (step 460). The merchant can then define filter criteria for the deal (step 465). For example, the merchant can limit the deal to specific locations, to a specified area (e.g., a zip code), to cardholders (i.e., accountholders) with select purchasing history, or to cardholders with a certain demographic profile. In step 470, the merchant specifies the distribution criteria (e.g., demographics, geographic purchasing behavior, etc.) that define which consumers will be sent notice of the deal, and System 200 sends the deal notice to consumers based on the distribution criteria. Deal notices may be sent via email, web, social network, and mobile text messaging. Through the merchant portal 230, the merchant may also view various reports (e.g., statistics/data related to deals and campaigns) and manage his accounts (step 480).

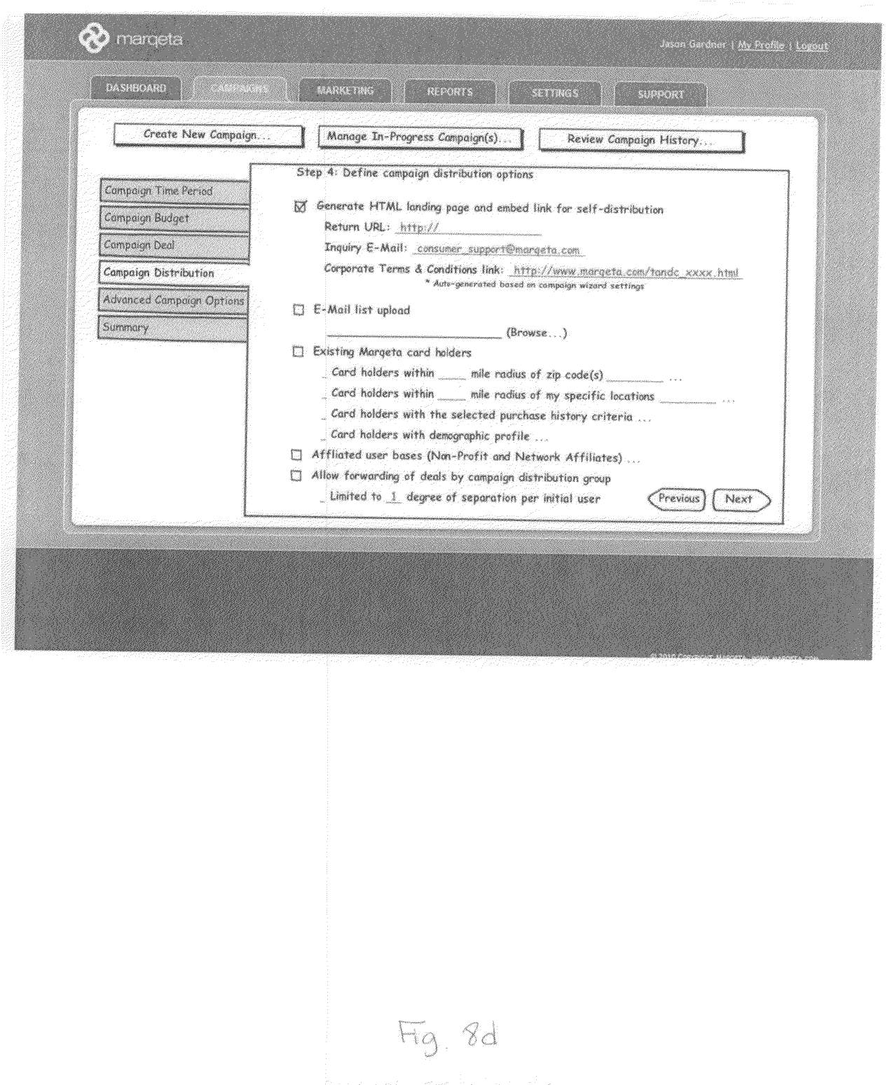

FIGS. 8a-8e illustrate an example user interface in the Merchant Portal 230 via which a merchant can define a deal. In FIG. 8a, the merchant defines timeframes for a campaign. In FIG. 8b, the merchant specifies rules for when a campaign expires (e.g., based on number of reward dollars, prepaid dollars, or number of deals). In FIG. 8c, the merchant defines the deal. In FIG. 8d, the merchant defines campaign distribution options. In FIG. 8e, the merchant may specify additional limitation or filters and otherwise further customize the deal.

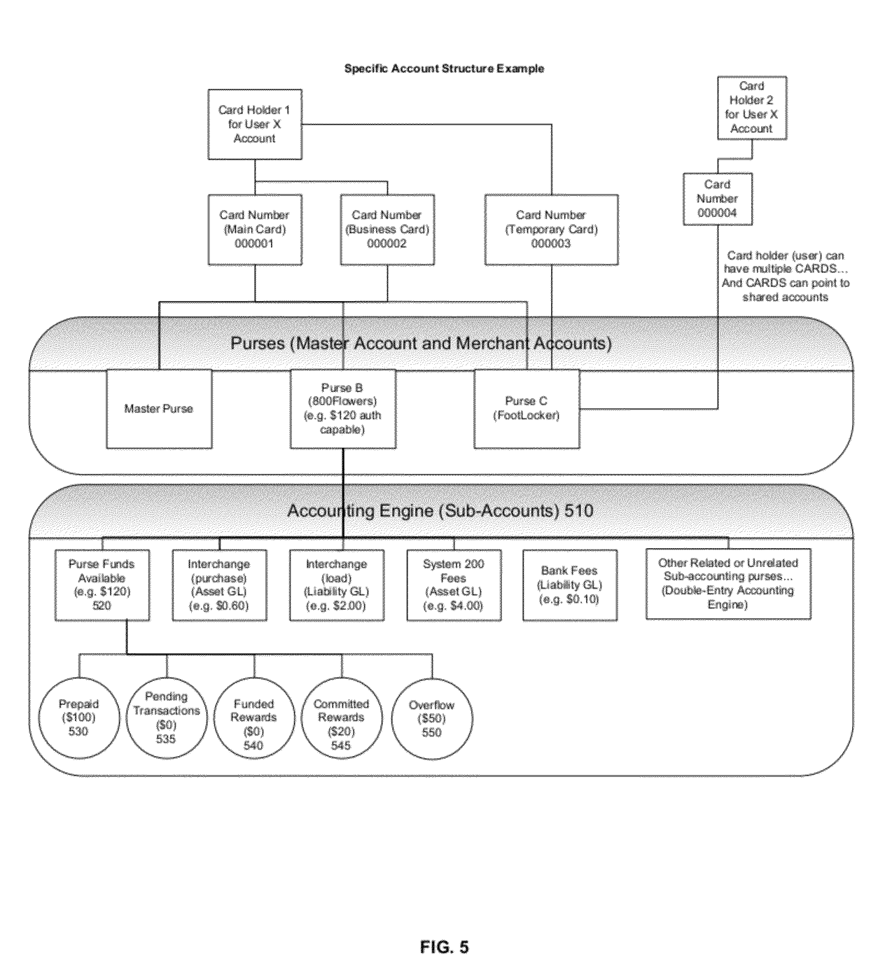

FIG. 5 illustrates an example of the account structure and architecture within database 210 that is used to manage transactions and accounting. In this example, User X has two cardholders associated with his account (e.g., User X and his spouse). In the database, cardholder 1 is associated with card numbers 000001 and 000002, and cardholder 2 is associated with card number 000004. Card numbers 000001 and 000002 both point to the master purse and merchant purses B and C, and thus these purses are shared between the two cards. Also, card number 000004 also points to purse C. Cardholders can have multiple cards, and cards can point to shared accounts. In this example, only cardholder 1 (via cards 000001 and 000002) is able to access the master purse and purse B, but both cardholder 1 and 2 have access to purse C.

The account also has temporary card 00003 associated with cardholder 1 and purse C. In one embodiment, the system is capable of generating an electronic temporary card that can be used for a specific merchant purse before a user's physical card for the account arrives. The temporary card is a number that can be punched in online or at POS as a card-not-present. transaction. The temporary card may be configured for one-transaction use for added security.

Purse B points to sub-account entries 510 associated with purse B. The sub-account entries include the available purse funds 520, as well as all the various bank and interchange fees. The “Purse Funds Available” sub-account 520 points to additional sub-accounts 530, 535, 540, 545 and 550 that include the prepaid and reward balances that together add up to the available purse funds in sub-account 520. “Pre-paid” sub-account 530 represents prepaid funds in the user's account. “Pending” sub-account 535 represents the price any pending purchase transaction. “Funded Rewards” sub-account 540 represents rewards that have been funded by a merchant. “Committed Rewards” sub-account 545 represents rewards earned by the accountholder but not yet funded by the merchant. “Overflow” Sub-account 550 represents amounts charged to an overflow fund.

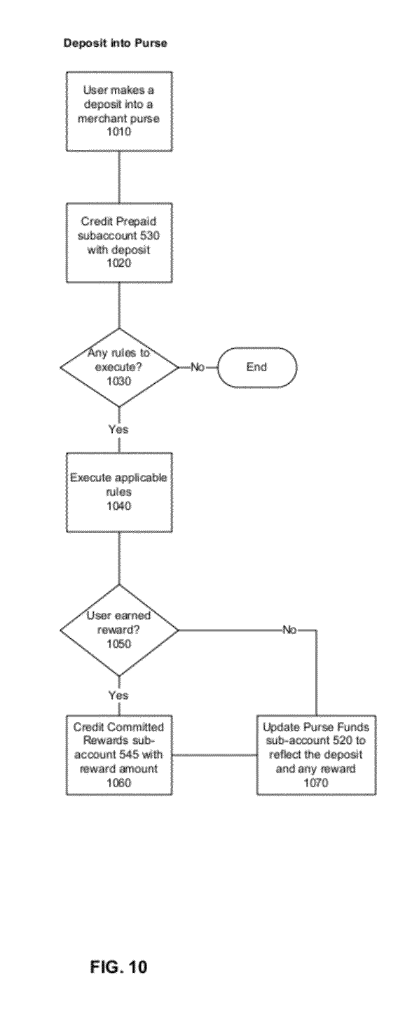

FIG. 10 illustrates the process associated with a user deposit into a purse in accordance with one embodiment of the invention. The user makes a deposit into a merchant purse (step 1010). System 200 credits Prepaid sub-account 530 with the deposit (step 1020). If there are any rules associates with the deposit, System 200 executes the rule(s) (steps 1030, 1040). If the user has earned a reward, System 200 credits Committed Rewards sub-account 545 with the reward amount (steps 1050, 1060), and updates Purse Funds sub-account 520 to reflect the deposit and any reward (step 1070).

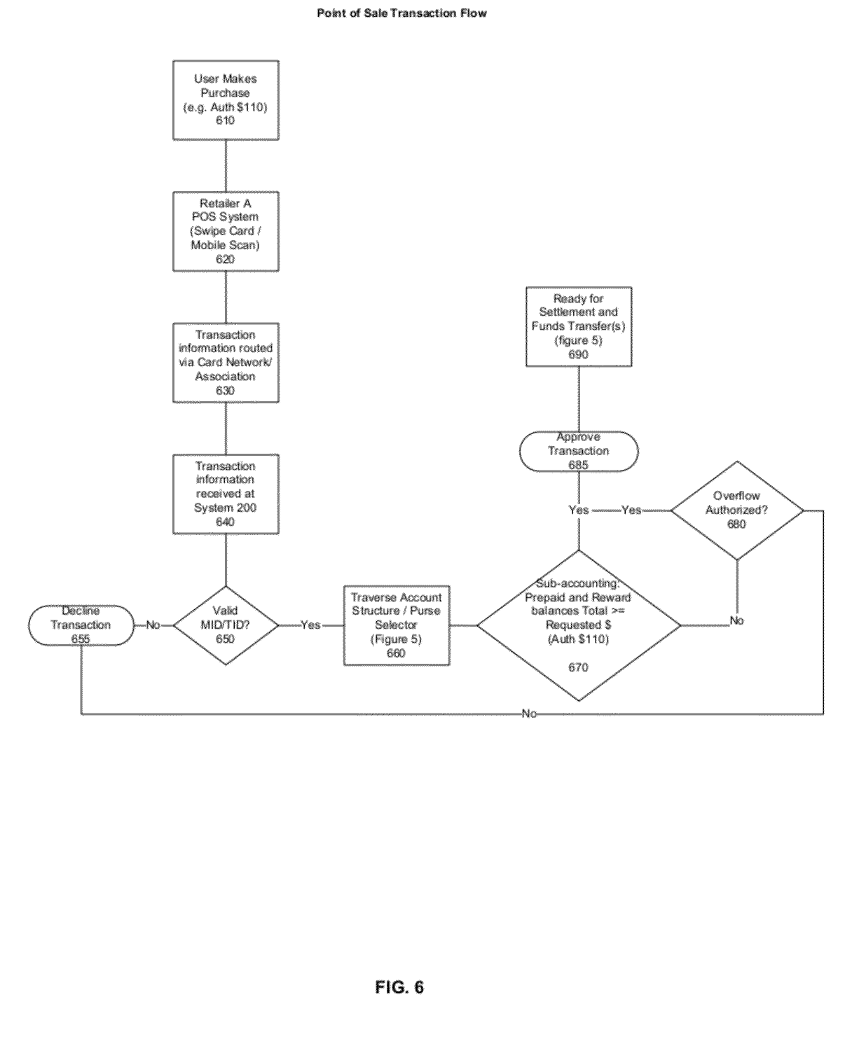

FIG. 6 illustrates an authorization transaction flow from the merchant's existing POS system, through the credit card network, to System 200, according to one embodiment of the present invention. The process begins when user attempts to make a purchase using his multi-merchant prepayment card (step 610). Retailer A swipes or scans the card at its POS system (620). The purchase and card data is routed through the credit card network/association to System 200 (steps 630 and 640). Authorization Engine 240 determines whether the information includes a valid MID/TID pairs (step 650). If not, the transaction is declined (step 655). If the MID/TID pair is valid, the Authorization Engine 240 traverses database 210 to find the applicable cardholder and merchant purse (step 660) After finding the applicable merchant purse, Authorization Engine 250 further traverses the database 210 to the sub-account layer 210d to determine if the purse funds are greater than or equal to the purchase amount (step 670). If the purse funds are insufficient, Authorization Engine 240 determines if there is an overflow account associated with the purse with sufficient funds/credit for the remaining balance on the purchase (step 680). If not, the transaction is declined (step 655). If the purse funds and/or an overflow account are sufficient, the transaction is approved (step 685). Sub-Accounting Rules Engine 250 applies sub-accounting rules to ready prepaid and reward funds for financial settlement by the card issuer network (step 690). The sub-accounting rules define which funds are used in the deal sub-accounts layer 210f to settle the transaction.

FIG. 7 illustrates a settlement and funding flow according to one embodiment of the present invention. After a transaction has been authorized, the Settlement Engine 260 determines whether or not the settlement (i.e., the purchase amount) is greater than or equal to Prepaid sub-account 530 in Database 210 (see FIG. 5) (step 710). If not, then the settlement amount is less than the dollar amount prepaid by the user, and only Prepaid sub-account 530 is debited for the settlement amount (step 715). Funds are settled with the applicable Payment Network Association (step 720).

If the settlement amount is greater than Prepaid sub-account 530, then the settlement is greater than the user's prepaid dollar amount. The settlement engine 260 debits any remaining balance in Prepaid sub-account 530 and flags funds in Committed Rewards sub-account 545 for transfer into Funded Rewards sub-account 540 (steps 730, 740). This means that previously committed, but unfunded merchant rewards will become funded rewards.

The settlement engine 260 determines if the remaining settlement amount is less than the Committed Rewards and Funded Rewards sub-accounts 540, 545 (step 745). If not, then all the rewards amounts will be used for the transaction. The settlement engine debits Committed Rewards sub-account 545 to $0 and transfers the committed reward funds to Funded Rewards sub-account 540 (step 750). All the funds from the Funded Rewards sub-account 540 are applied to the remaining settlement amount and the funds are settled with the applicable Payment Network Association (step 755). If there is an overflow balance, such balance is charged to the applicable overflow account.

If the remaining settlement amount is less than the Committed Rewards sub-account 545, then the settlement engine debits the Committed Rewards sub-account 545 to zero and transfers the committed rewards amount into Funded Rewards sub-account 540 (step 760). The settlement engine applies funds from the Funded Rewards sub-account 540 to the remaining settlement balance (step 765). The Funded Rewards sub-account 540 keeps the remaining, partial rewards balance (step 770). This is in separate accounting layer in order to address refund business rule options. The prepaid funds and debited rewards funds are settled with the applicable Payment Network Association (step 775).

The methods described with respect to FIGS. 1 and 3-10 are embodied in software and performed by a computer system executing the software. A person skilled in the art would understand that a computer system has a memory or other physical, computer-readable storage medium for storing software instructions and one or more processors for executing the software instructions.

As will be understood by those familiar with the art, the foregoing invention may be embodied in other specific forms without departing from the spirit or essential characteristics thereof. Accordingly, the above disclosure of the present invention is intended to be illustrative and not limiting of the invention.

1. A method for providing a single user account that separately tracks credit balances for multiple merchants, the method comprising:
associating a plurality of merchant purses with a single user account, wherein a user is able to use the account to make purchases at the merchants associated with the purses;
tracking a separate balance for each merchant purse, including tracking a prepaid balance within each merchant purse;
in response to the user depositing prepaid money into one of the merchant purses, crediting the applicable merchant purse with the deposited amount;
in response to the user performing a purchase transaction at one of the merchants associated with one of the purses, debiting the purse in the user's account associated with the applicable merchant.

2. The method of claim 1, further comprising:
in response to the user depositing prepaid money into one of the merchant purses, calculating a rewards amount associated with the deposited amount; and
crediting the applicable merchant purse with the calculated rewards amount.

3. The method of claim 1, enabling the user to enroll in a deal from a merchant in which a user receives a reward for a merchant in response to depositing a threshold prepaid amount in a merchant purse associated with the merchant.

4. The method of claim 3, wherein, in response to the user enrolling in the deal, associating one or more rules with the applicable merchant purse that provide for the calculation of a rewards amount in accordance with the deal.

5. The method of claim 4, wherein each of the merchant purses is associated with its own set of rules for calculating a rewards amount.

6. The method of claim 5, wherein in response to the user depositing prepaid money into one of the merchant purses, executing one or more rules associated with the merchant purse to calculate a rewards amount, and, in response to the rewards amount being greater than zero, crediting the merchant purse with rewards amount.

7. The method of claim 6, wherein within each merchant purse is a prepaid subaccount for tracking the user's prepaid balance with a merchant and a rewards subaccount for tracking the user's reward balance with the merchant, and wherein debiting a merchant purse comprises debiting the prepaid subaccount first and debiting the rewards subaccount only if the prepaid subaccount is depleted.

8. The method of claim 6, further comprising:
enabling a merchant purse to be associated with one or more rules that specifies restrictions for use of a reward; and
prior to debiting a rewards balance, executing any applicable rule related to use of a reward within the merchant purse.

9. The method of claim 6, wherein a reward is calculated based on a one-time deposit of prepaid money by the user.

10. The method of claim 6, wherein a reward is calculated based on one or more deposits of prepaid money by the user over a specified time period.

11. The method of claim 1, further comprising enabling a user to associate an overflow account with one or more of the merchant purchases, wherein, for any merchant purses associated with the overflow account, the remaining balance of a purchase that exceeds that balance of the merchant purse is charged to the overflow account.

12. The method of claim 11, wherein a user may specify that the overflow account is a default overflow account applicable to multiple merchant purses or that the overflow account is specific to a particular merchant.

13. The method of claim 11, further comprising:
separately tracking amounts spent by the user at one or more of the merchants, regardless of whether the user used prepaid dollars or an overflow account;
calculating rewards from one or more merchants based on amount spent at the merchant using the user account; and
in response to a user earning a reward at a merchant, crediting the applicable merchant purse with the reward.

14. The method of claim 13, wherein a reward calculation is specific to a particular merchant store.

15. The method of claim 13, wherein a reward calculation is specific to a particular merchant department.

16. The method of claim 1, further comprising associating a master purse with the user's account, wherein the master purse is not specific to a particular merchant and wherein the user is able to allocate funds deposited into the master purse to one or more specific merchant purses.

17. The method of claim 1, wherein identifying information for the user account is loaded onto a physical card that can be swiped at a merchant location.

18. The method of claim 1, wherein identifying information for the user account is loaded onto a mobile computing device and wherein the mobile computing device is scanned to obtain the identifying information.

19. A computer program embodied on a non-transitory computer-readable medium and comprising code, that, when executed by a computer system, enables the computer system to perform the following method for providing a single user account that separately tracks credit balances for multiple merchants, the method comprising:
associating a plurality of merchant purses with a single user account, wherein a user is able to use the account to make purchases at the merchants associated with the purses;
tracking a separate balance for each merchant purse, including tracking a prepaid balance within each merchant purse;
in response to the user depositing prepaid money into one of the merchant purses, crediting the applicable merchant purse with the deposited amount;
in response to the user performing a purchase transaction at one of the merchants associated with one of the purses, debiting the purse in the user's account associated with the applicable merchant.

20. The computer program of claim 19, further comprising:
in response to the user depositing prepaid money into one of the merchant purses, calculating a rewards amount associated with the deposited amount; and
crediting the applicable merchant purse with the calculated rewards amount.

21. The computer program of claim 19, enabling the user to enroll in a deal from a merchant in which a user receives a reward for a merchant in response to depositing a threshold prepaid amount in a merchant purse associated with the merchant.

22. The computer program of claim 21, wherein, in response to the user enrolling in the deal, associating one or more rules with the applicable merchant purse that provide for the calculation of a rewards amount in accordance with the deal.

23. The computer program of claim 22, wherein each of the merchant purses is associated with its own set of rules for calculating a rewards amount.

24. The computer program of claim 23, wherein in response to the user depositing prepaid money into one of the merchant purses, executing one or more rules associated with the merchant purse to calculate a rewards amount, and, in response to the rewards amount being greater than zero, crediting the merchant purse with rewards amount.

25. A system for providing a single user account that separately tracks credit balances for multiple merchants, the system comprising:
a processor; and
a memory coupled to the processor, wherein the memory stores instructions that, when executed by the processor, cause the system to perform the operations of:
associating a plurality of merchant purses with a single user account, wherein a user is able to use the account to make purchases at the merchants associated with the purses;
tracking a separate balance for each merchant purse, including tracking a prepaid balance within each merchant purse;
in response to the user depositing prepaid money into one of the merchant purses, crediting the applicable merchant purse with the deposited amount;
in response to the user performing a purchase transaction at one of the merchants associated with one of the purses, debiting the purse in the user's account associated with the applicable merchant.

26. The system of claim 25, further comprising:
in response to the user depositing prepaid money into one of the merchant purses, calculating a rewards amount associated with the deposited amount; and
crediting the applicable merchant purse with the calculated rewards amount.

27. The system of claim 25, enabling the user to enroll in a deal from a merchant in which a user receives a reward for a merchant in response to depositing a threshold prepaid amount in a merchant purse associated with the merchant.

28. The system of claim 26, wherein, in response to the user enrolling in the deal, associating one or more rules with the applicable merchant purse that provide for the calculation of a rewards amount in accordance with the deal.

29. The system of claim 27, wherein each of the merchant purses is associated with its own set of rules for calculating a rewards amount.

30. The system of claim 28, wherein in response to the user depositing prepaid money into one of the merchant purses, executing one or more rules associated with the merchant purse to calculate a rewards amount, and, in response to the rewards amount being greater than zero, crediting the merchant purse with rewards amount.
